(19) United States
(12) Patent Application Publication
(10) Pub. No.: US 2022/0307319 A1
(43) Pub. Date: Sep. 29, 2022

(54) ELECTROMECHANICAL DEVICE FOR MANAGING CORD LOOPED WINDOW BLINDS, CURTAINS, AND SHADES

(71) Applicant: Chase Lepkanich, Syosset, NY (US)

(72) Inventor: Chase Lepkanich, Syosset, NY (US)

(73) Assignee: Linked Labs LLC, Fort Myers, FL (US)

(21) Appl. No.: 17/214,854

(22) Filed: Mar. 27, 2021

(51) Int. Cl. E06B 9/38; G05B 15/02

(52) U.S. Cl. CPC E06B 9/38; G05B 15/02; H04W 4/80

(57) ABSTRACT

In an embodiment, a system for managing window blinds is provided. The system comprises an electronic device and an application stored on the device that when executed directs, based on a stored schedule, blinds for a first group of windows in a room in a structure to execute a first action. The system also directs, based on the schedule, blinds for a second group of windows in the room to execute a second action. The system also directs, based on the schedule, blinds for the first and second groups to take a third action. The actions comprise at least one of opening slats, closing slats, opening the blinds, and closing the blinds. The application transmits the directions to the groups via at least one of Internet connection, WiFi connection, and other wireless connections via an intermediary device and via Bluetooth and transmits via Bluetooth without intermediary device.

### CROSS REFERENCE TO RELATED APPLICATIONS

This non-provisional patent application is related to provisional U.S. Patent Application No. 63/001,357 filed Mar. 29, 2020, the contents of which are incorporated herein in their entirety.

### FIELD OF THE INVENTION

The present disclosure is in the field of home and building furnishings. More particularly, the present disclosure provides systems and methods of remotely controlling a plurality of window blinds allowing multiple blinds to be remotely controlled in groups and on a scheduled basis subject to at least sensor data describing ambient light and temperature conditions proximate the managed window blinds.

### BACKGROUND

A window blind is a type of window covering. Many different kinds of window blinds use a variety of control systems. A typical window blind is made up of several long horizontal or vertical slats of various types of hard material, including wood, plastic or metal which are held together by cords that run through the blind.

Window blinds can be maneuvered by rotating them from an open position, with slats spaced out, to a closed position where slats overlap and block out most light. Window blinds can also be controlled through a cord loop where the blinds are opened and closed from top height to bottom height or in between by pulling the cord loop in either direction, thus up or down.

Window blinds, curtains, and shades are a key element of residential and office quality of life. Managing the amount of natural or manmade light entering a living space or workspace is an important aspect of maintaining quality of life residentially and in leisure settings as well as productivity in the workplace. Such blinds also assist in maintaining privacy and safety.

### BRIEF DESCRIPTION OF THE FIGURES

FIG. 1 is a block diagram of a system of an electromechanical device for managing cord looped window blinds, curtains, and shades according to an embodiment of the present disclosure.

FIG. 2 is an image of the system according to an embodiment of the present disclosure.

FIG. 3 is an image of the system according to an embodiment of the present disclosure.

FIG. 4 through FIG. 7 are images of components of the system according to embodiments of the present disclosure.

### DETAILED DESCRIPTION

Systems and methods described herein provide for management of individual and groups of electromechanical devices located at window blinds to achieve more efficient energy usage as well as support user comfort and safety. The blinds may be installed at sets of windows in a room, in a building or home, or in separate structures. Executing on a computer or mobile device, for example a smartphone, remote from the electromechanical devices and managed blinds, the system wirelessly directs the electromechanical devices to at least partially open or close blinds and/or slats within blinds.

Working remotely with an intermediary device such as a hub that is located near the electromechanical devices and their corresponding blinds, the system may create and alter schedules, and may cause various actions by blinds and groups thereof on an impromptu or one-off basis. The system may also obtain device information about blinds and their controller modules and may perform factory resets.

The system may receive information from sensors located near managed blinds. Based on the information received, the system may immediately adjust the blinds near the sensors on an impromptu basis or the system may make permanent or semi-permanent changes to schedules for individual blinds or groups of blinds. Such sensors may monitor temperature, ambient light, or other environmental condition in a room or other area. Other sensors include switches and proximity sensors.

The system executing remotely on a smartphone or other device communicates with controller modules inside the electromechanical devices located at each window. Controller modules are installed on printed circuit boards contained within each electromechanical device per window. The controller modules execute instructions received from the system and pass information back to the system. The controller modules cause electromechanical components including motors at each window unit to physically move the blinds and their component.

The system uses an internet connection (or a local network via Ethernet or other means) to communicate with the controller modules via an intermediary device such as a hub. The hub relays communications between the system, usually remote, and the controller modules within the electromechanical devices at the blinds. An advantage of having the system use an intermediary device such as a hub is that the intermediary device can simultaneously direct multiple control modules using Zigbee or similar technology. The system can therefore remotely control groups of electromechanical devices and their corresponding window blinds. The controller modules at each window receive commands from the system and execute the commands as a group if so configured.

The controller modules located at each window, in addition to executing commands from the remote system, handle logic as well as communications that may be via Bluetooth, Thread or Zigbee communications or other wireless connectivity means. In addition to controlling motors to move blinds, controller modules handle components that include but are not limited to LEDs, buttons, charging status, RTC (real time clock), sensors, and internal memory, actuators, indicators, memories, and power management systems.

The microcontroller unit or chipset used in controller modules may be embedded into controller modules that contain the wireless antenna, as well as the package to electrically connect to pads on printed circuit boards (PCB) to which the modules are attached. In an embodiment, the microcontroller unit may not be in a controller module and may instead be a standalone microcontroller unit wherein the antenna is separate.

The software on the remote device, for example a smartphone, hosting the system may gather pertinent information about the health and status of the electromechanical device including controller module, printed circuit board, motor, and other electromechanical parts at the window. The system also gathers battery level, battery charging status, battery current, battery overcurrent warning, battery overcharging warning, battery over-discharge warning, and other related battery information. The system also gathers motor position (blind position), motor error (if motor is locked and cannot move), motor current, motor overcurrent warning, and other motor related information. The system also exhibits firmware version, hardware version, manufacturer, serial number, and other relevant data field.

The system executing on the remote device allows the user to customize the LEDs on some of the buttons located on the electromechanical devices at the window. A user can change the brightness, timeout (how long the lights take to turn off after an action has been performed) and schedule (for example, if the lights should be always off during the night).

Following is a discussion of components of the electromechanical device attached to a wall or other surface near a window and which moves the blinds. The electromechanical device includes the controller module, the printed circuit board which physically hosts the controller module, the motor which physically causes movement of the blinds, and other hardware. The components of the electromechanical device are controlled by instructions received from the remote device hosting the system which comprises at least one application executing at least on the remote device and on additional devices in some embodiments.

The electromechanical device operates cord-looped blinds via use of on-device controls or remote control as described above. The electromechanical device contains an electrical motor with a sprocket on its shaft that takes hold of a blind cord and moves the blind up or down to open and close the blind.

Mounting of the electromechanical device on a wall is accomplished by a supplied wall mount bracket. This bracket is height adjustable to compensate for user error in wall bracket positioning, so sufficient tension to the cord is provided and no cord slips can occur.

Capacitive touch buttons and a mechanical button are the on-device controls needed to fully operate the electromechanical device. The touch buttons instruct the electromechanical device to move the blinds up or down, activate Bluetooth pairing mode and other functions. A mechanical button on the electromechanical device performs a factory reset of the electromechanical device.

The electromechanical device receives power from two sources comprising battery and external power supply or a combination of them. The sources are internal battery and external power source. By external power source, this encompasses power supplies, external batteries, and solar panels.

The electromechanical device may be contained in a plastic enclosure that consists of injection molded parts put together. The components of the enclosure are as follows:
Lid—Front of the device, showing the touch buttons and covering the entire length and width of the device. Electronics (PCB, motor and battery) will be assembled on this plastic part. It has ring-shaped openings around the touch button area for allowing entry of LED light and other types of light. There is an opening at the bottom for a connector to go through.
Base—The base rests on the back side of the electromechanical device, covering the electronics and providing mechanical connection to the wall bracket. It has an opening to allow the motor shaft to go through it.
Sprocket—Wheel that attaches to the motor shaft and connects with the blind cord to pull it up or down.
Sprocket Cover—Safety cover to protect the user's fingers from being pinched by the blind cord and sprocket. It will partially cover the sprocket and it has an opening near the top to allow the blind cord to pass through.
Wall Bracket—Bracket that is attached to the base for mounting the device on a wall.
LED Rings—a translucent component that diffuses LED light coming from the printed circuit board. This component is mounted below the lid and above the LEDs on the PCB.

The motor may be a DC, Stepper, or other motor with or without an on-board magnetic encoder. Connection of the motor to the PCB may be done via a cable or cable bundle that will transfer the electrical signals. The motor may have a shaft for which the sprocket attaches to, which may mount to the lid plastic part via an adhesive agent, self-tapping screws, or other connective measures.

The battery is internal and not meant for replacement or removal by a user. The battery has an external charging function.

The PCB may be approximately the size of the lid plastic part and mounts to the lid plastic part with self-tapping screws. In embodiments PCB may be larger or smaller. The PCB contains the logic, power and interface systems while providing extra mechanical rigidity to the assembly.

There are two main sources of power: external adapter (such as a USB Type-C connector, micro-USB, or similar) and battery. A charger chip manages which source provides power to the system:
If the battery is completely discharged or not present, the power comes from the external adapter.
If the battery is partially charged, the system will receive power from both sources.
If the battery is fully charged, the system will receive power from the external adapter (if the external adapter is not connected, power is provided only by the battery).

Using a light sensor, the electromechanical device can measure intensity of ambient light. A user sets desired light intensity and the electromechanical device can raise or lower the blinds to maintain desired intensity.

With a temperature sensor, the electromechanical device can also achieve automation for temperature. When configured, the electromechanical device attempts to maintain desired temperatures in the room by opening and closing the blinds accordingly. This lets greater or lesser amounts of natural light into the interior space, thus increasing or decreasing the heat input from the exterior.

The electromechanical device has a system to keep time accurately, even when the battery is low or the system is off.

The data stored in the PCB is variable and encompasses items such as blind schedules, hard information (PCB version number, manufacturer, firmware version), Bluetooth pairing information, last state (before power off), blind position.

The electromechanical device includes capacitive touch buttons which enable a user to control on-device functions including but not limited to opening blinds, closing blinds, pairing, and system reset.

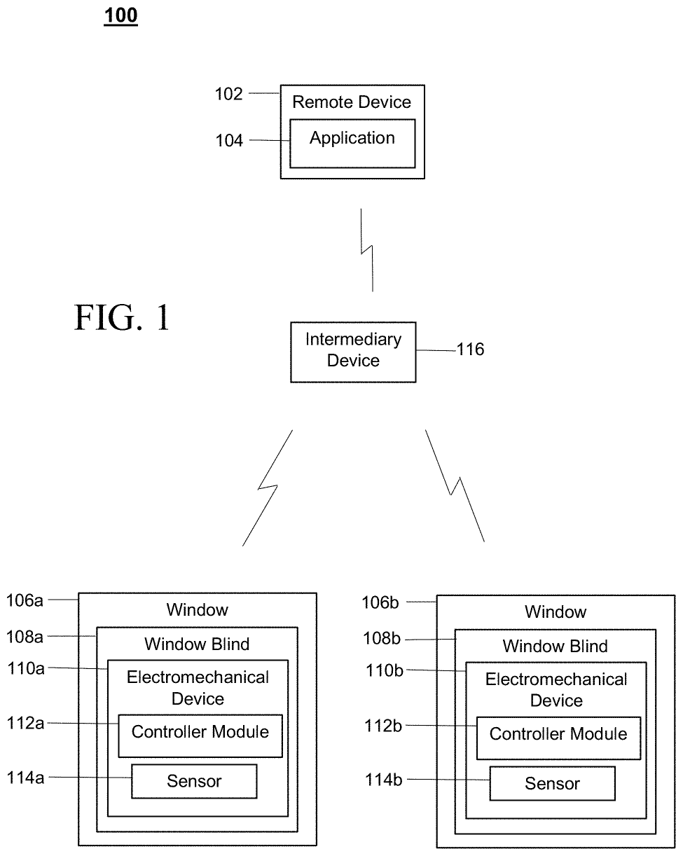

Turning to the figures, FIG. 1 is a block diagram of a system of an electromechanical device for managing cord looped window blinds, curtains, and shades according to an embodiment of the present disclosure. FIG. 1 depicts components and interactions of a system 100.

System 100 comprises a remote device 102, an application 104, windows 106a-b, window blinds 108a-b, and electromechanical devices 110a-b. System 100 also comprises controller modules 112a-b, sensors 114a-b, and an intermediary device 116.

Although two of windows 106a-b, window blinds 108a-b, electromechanical devices 110a-b, controller modules 112a-b and sensors 114a-b are provided by the system 100, in embodiments more than or fewer than two of these components are provided. While the sensors 114a-b are shown as components of the window blinds 108a-b and contained within electromechanical devices 110a-b, in embodiments the sensors 114a-b are independent of the blinds 108a-b, are placed not proximate to window blinds 108a-b, and do not correspond in quantity to the window blinds 108a-b on a one-on-one basis. While much of the discussion herein is directed to window blinds, it is understood that window blinds 108a-b also include shades, curtains, and coverings for windows. Window blinds 108a-b may in embodiments may not be used in conjunction with windows and may be used to cover or obstruct other surfaces or objects.

For brevity and simplicity, many components provided herein that are essential to systems and methods provided herein are not depicted in FIG. 1. These components comprise at least printed circuit boards, batteries, motors, sprockets, and antennae.

As noted, the remote device 102 may be a mobile device such as a smartphone or may be a laptop, tablet, or desktop computer. As discussed extensively above, the remote device 102 via the application 104 executing thereon can remotely control many window blinds 108a-b via the intermediary device 116 and the controller modules 112a-b. When the remote device 102 is proximate the electromechanical devices 110a-b that house the controller modules 112a-b, the remote device 102 need not communicate via the intermediary device 116 and may communicate directly with individual electromechanical devices 110a-b. The electromechanical device 110a-b may be a retrofit design that allows the electromechanical device 110a-b to be adaptable to most or all cord loop window shades or blinds by attaching to the bottom of the cord loop. The electromechanical device 110a-b attaches to the bottom of the blind string via the sprocket that is secured onto the motor, where the cord loop is strung around.

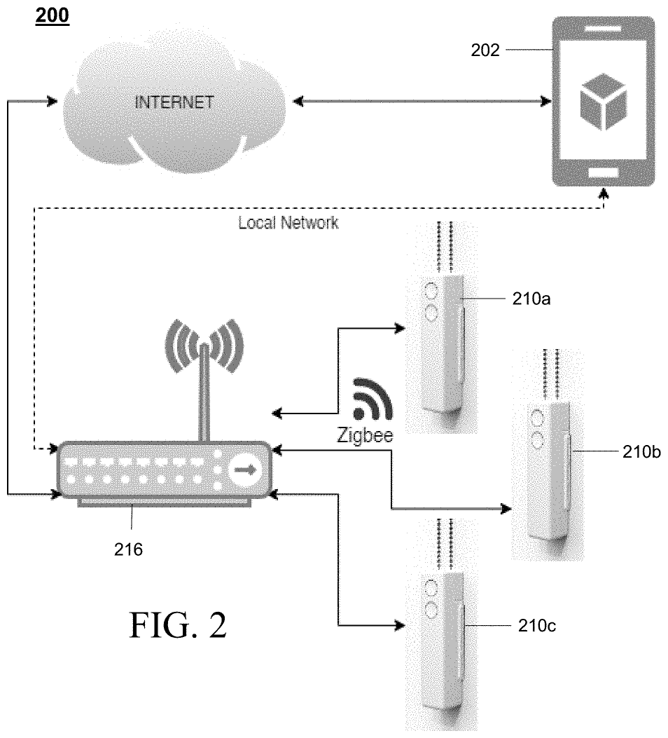

FIG. 2 is an image of the system with components indexed to the components of the system 100. FIG. 2 depicts a system 200 including a remote device 202, electromechanical devices 210a-c, and an intermediary device 216. As is shown, Zigbee technology or similar wireless technology may be used for the intermediary device 216 to transmit to the electromechanical devices 210a-c.

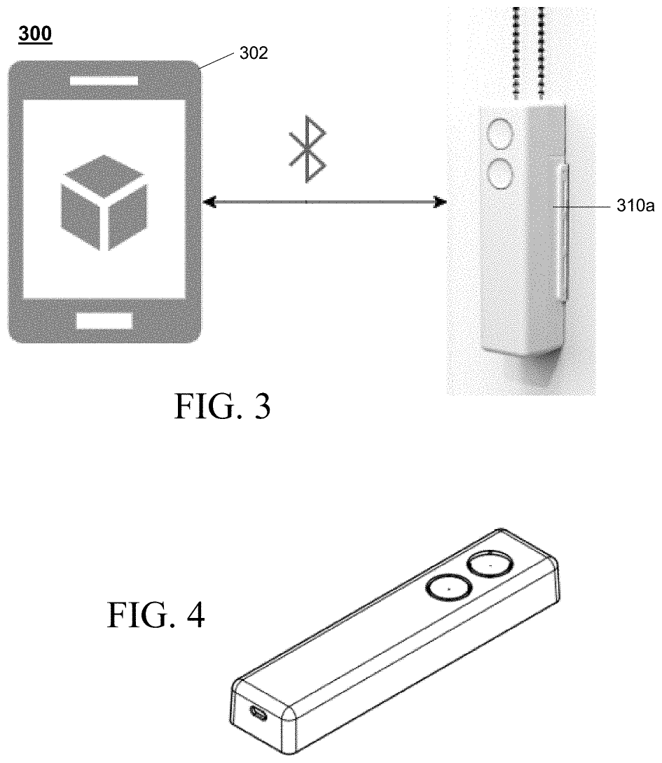

FIG. 3 is an image of the system with components indexed to the components of the system 100. FIG. 3 depicts a system 300 including a remote device 302 and an electromechanical device 310a. As shown, Bluetooth or similar wireless technology may be used when the remote device 302 is proximate to the electromechanical device 310a and the intermediary device is not used.

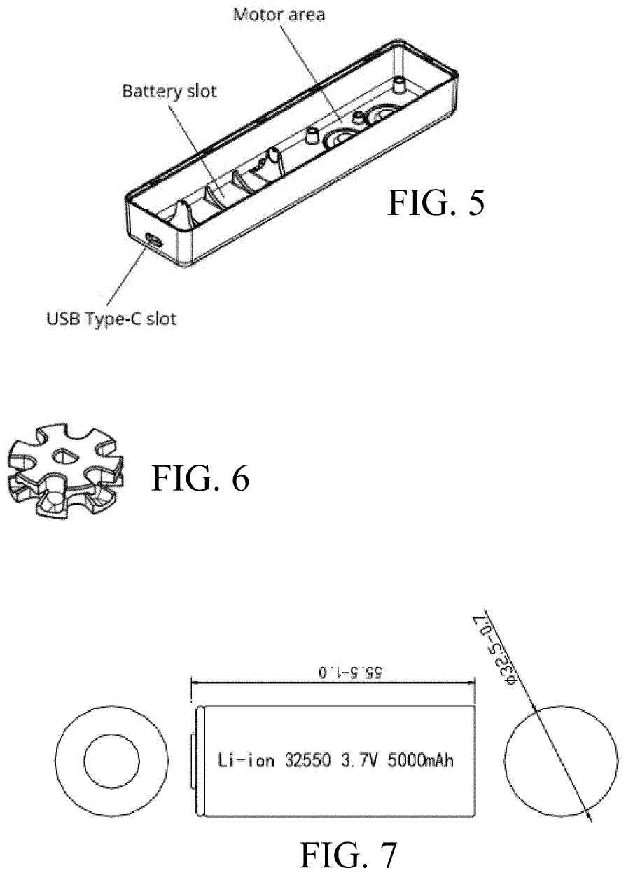

FIG. 4 is an image of the exterior of the electromechanical device 110a-b. FIG. 5 is an image of the interior of the electromechanical device 110a-b. FIG. 6 is an image of the sprocket used to physically grasp blind cords to raise and lower window blinds 108a-b. FIG. 7 is a specification of a sample battery that may be used.

In an embodiment, a system for managing window blinds is provided. The system comprises an electronic device and an application stored on the device that when executed directs, based on a stored schedule, blinds for a first group of windows in a room in a structure to execute a first action. The system also directs, based on the schedule, blinds for a second group of windows in the room to execute a second action. The system also directs, based on the schedule, blinds for the first and second groups to take a third action. The actions comprise at least one of opening slats, closing slats, opening the blinds, and closing the blinds. The application transmits the directions to the groups via at least one of Internet connection, WiFi connection, and other wireless connections via an intermediary device and via Bluetooth and transmits via Bluetooth without intermediary device. The intermediary device is proximate the groups and communicates based on one of Zigbee, Thread, WiFi, and other technologies to transmit the received directions to the groups. The directions are implemented by controller modules associated with electromechanical devices located at each blind. The electromechanical devices physically execute the actions based on instructions from the controller modules. The first group and the second group are alternatively located in separate rooms in the structure. The application changes the schedule and changes windows within the groups and positions of individual window blinds based on a plurality of factors. The factors comprise time of day, day of the week, time of year, present and forecasted weather, and sensor data. The sensor data is received from sensors located in and proximate the structure, the sensors tracking at least one of ambient light and temperature.

In another embodiment, a system for managing groups of smart window blinds is provided. The system comprises a computing device and an application executing on the computing device that receives a first sensor measurement result for a first room within a structure. The system also determines that data in the result one of reaches and exceeds a predetermined threshold. The system also alters, one of temporarily and permanently and based on the determination, a stored first schedule for managing a first group of blinds for a first group of windows in the first room. The system also transmits the altered first schedule to controller modules controlling the first group of blinds. The controller modules cause electromechanical devices associated with each blind in the first group to take at least one physical action. The at least one physical action comprises at least one of opening slats, closing slats, opening the blinds, and closing the blinds. The first sensor measurement result is generated by a sensor associated with the first room, the sensor measuring at least one of ambient light and temperature associated with the first room. When the computing device is remote from the structure, the computing device uses at least one of Internet connection, WiFi connection, and other connection to communicate with the controller modules via an intermediary device, and when the computing device is not remote from the structure, the computing device does not use the intermediary device and instead uses Bluetooth to communicate with the controller modules.

In yet another embodiment, a method for remotely managing window blinds is provided. The method comprises a first controller module associated with a first window blind receiving a first instruction. The method also comprises a second controller module associated with a second window blind receiving a second instruction. The method also comprises the first module, based on the first instruction, at least one of opening and closing the first blind and opening and closing slats associated therewith. The method also comprises the second module, based on the second instruction, at least one of opening and closing the second blind and opening and closing slats associated therewith. The method also comprises the first controller module and the second controller module receiving the instructions from an application executing on a remote computer. The method also comprises the remote computer transmitting the instructions based on receipt of sensor data. The method also comprises sensors located proximate the window blinds transmitting the data comprising at least one of ambient light data, temperature data, and other data. The method also comprises the controller modules receiving the instructions further based on at least one of temporary and permanent schedule changes for window blind actions and/or one of additionally and alternatively based on impromptu calculations performed by the remote computer. Windows associated with the controller devices are located one of the same room in a structure, in different rooms in the structure, and in different structures.

What is claimed is:

1. A system for managing window blinds, comprising:
an electronic device;
an application stored on the device that when executed:
directs, based on a stored schedule, blinds for a first group of windows in a room in a structure to execute a first action,
directs, based on the schedule, blinds for a second group of windows in the room to execute a second action, and
directs, based on the schedule, blinds for the first and second groups to take a third action,
wherein the actions comprise at least one of opening slats, closing slats, opening the blinds, and closing the blinds.

2. The system of claim 1, wherein the application transmits the directions to the groups via at least one of Internet connection, WiFi connection, and other wireless connections via an intermediary device and via Bluetooth and transmits via Bluetooth without intermediary device.

3. The system of claim 2, wherein the intermediary device is proximate the groups and communicates based on one of Zigbee, Thread, WiFi, and other technologies to transmit the received directions to the groups.

4. The system of claim 1, wherein the directions are implemented by controller modules associated with electromechanical devices located at each blind.

5. The system of claim 4, wherein the electromechanical devices physically execute the actions based on instructions from the controller modules.

6. The system of claim 1, wherein the first group and the second group are alternatively located in separate rooms in the structure.

7. The system of claim 1, wherein the application changes the schedule and changes windows within the groups and positions of individual window blinds based on a plurality of factors.

8. The system of claim 7, wherein the factors comprise time of day, day of the week, time of year, present and forecasted weather, and sensor data.

9. The system of claim 8, wherein the sensor data is received from sensors located in and proximate the structure, the sensors tracking at least one of ambient light and temperature.

10. A system for managing groups of smart window blinds, comprising:
a computing device;
an application executing on the computing device that:
receives a first sensor measurement result for a first room within a structure,
determines that data in the result one of reaches and exceeds a predetermined threshold,
alters, one of temporarily and permanently and based on the determination, a stored first schedule for managing a first group of blinds for a first group of windows in the first room, and
transmits the altered first schedule to controller modules controlling the first group of blinds.

11. The system of claim 10, wherein the controller modules cause electromechanical devices associated with each blind in the first group to take at least one physical action.

12. The system of claim 11, wherein the at least one physical action comprises at least one of opening slats, closing slats, opening the blinds, and closing the blinds.

13. The system of claim 10, wherein the first sensor measurement result is generated by a sensor associated with the first room, the sensor measuring at least one of ambient light and temperature associated with the first room.

14. The system of claim 10, wherein when the computing device is remote from the structure, the computing device uses at least one of Internet connection, WiFi connection, and other connection to communicate with the controller modules via an intermediary device, and when the computing device is not remote from the structure, the computing device does not use the intermediary device and instead uses Bluetooth to communicate with the controller modules.

15. A method for remotely managing window blinds, comprising:
a first controller module associated with a first window blind receiving a first instruction;
a second controller module associated with a second window blind receiving a second instruction;
the first module, based on the first instruction, at least one of opening and closing the first blind and opening and closing slats associated therewith; and
the second module, based on the second instruction, at least one of opening and closing the second blind and opening and closing slats associated therewith.

16. The method of claim 15, further comprising the first controller module and the second controller module receiving the instructions from an application executing on a remote computer.

17. The method of claim 16, further comprising the remote computer transmitting the instructions based on receipt of sensor data.

18. The method of claim 17, further comprising sensors located proximate the window blinds transmitting the data comprising at least one of ambient light data, temperature data, and other data.

19. The method of claim 15, further comprising the controller modules receiving the instructions further based on at least one of temporary and permanent schedule changes for window blind actions and/or one of additionally and alternatively based on impromptu calculations performed by the remote computer.

20. The method of claim 15, wherein windows associated with the controller devices are located one of the same room in a structure, in different rooms in the structure, and in different structures.
